(19) United States
(12) Patent Application Publication
(10) Pub. No.: US 2022/0261473 A1
(43) Pub. Date: Aug. 18, 2022

(54) SYSTEM AND METHOD FOR PROTECTING A LOGIN PROCESS

(71) Applicant: BEIJING DIDI INFINITY TECHNOLOGY AND DEVELOPMENT CO., LTD., Beijing (CN)

(72) Inventor: Jinjian Zhai, Mountain View, CA (US)

(73) Assignee: BEIJING DIDI INFINITY TECHNOLOGY AND DEVELOPMENT CO., LTD., Beijing (CN)

(21) Appl. No.: 17/177,126

(22) Filed: Feb. 16, 2021

(51) Int. Cl. G06F 21/45; G06F 21/42; G06N 20/00

(52) U.S. Cl. CPC G06F 21/45; G06F 21/42; G06F 2221/2133; G06F 2221/2103; G06N 20/00

(57) ABSTRACT

Embodiments of the disclosure provide systems and methods for protecting a login process to an application running on a device. The method may include interactively training a mock hacker artificial intelligence (AI) engine and a challenge generation AI engine to compete with each other. The challenge generation AI engine is configured to generate challenges that defeat hacking attacks by the mock hacker AI engine, and the mock hacker AI engine is configured to attack the challenges generated by the challenge generation AI engine. The method may further include generating a login challenge using the trained challenge generation AI engine. The method may additionally include providing the login challenge to a user attempting to access the application during the login process.

### TECHNICAL FIELD

The present disclosure relates to the field of login process protection, and more particularly relates to user account login verification for computer and mobile applications against hacks.

### BACKGROUND

As the Internet operation grows, numerous online applications have been developed. No matter whether it is a web-based application or a mobile application installed on a mobile device, in many cases the application will require a user to register for a user account, and every time the user wants to use the application, he needs to login into his user account. The user account may contain considerable number of private information about the user that should be protected and kept confidential to the user and application platform only. The user account may oftentimes also be a paid or payment receiving account. Therefore, the user account should only be accessible by the user himself or by a person authorized by the user. The login process typically asks the user to input his username and confidential password, and the process is designed to give access to only people who possess such information.

However, there are hackers attacking the login process to illegally gain access to information of account users. To defeat hackers, some verification mechanism has been developed, such as picture identification, word or number recognition, and audio or video format verification. Sometimes the hacker may take advantage of artificial intelligence (AI) engine to attack the login process, which automatically activates multiple verifications in a short period of time. Therefore, a verification mechanism to protect login process that can defeat a hacker AI engine is needed in the field.

In some login process, the login process is protected by a two-step verification, such as via a mobile application or a short message services (SMS). However, a hacker AI engine may automatically send a large number of two-step verification requests to a vulnerable login portal using different phone numbers. The login server may initiate a large number of SMS messages to those phone numbers in response. At the same time, the login server may provide feedback to the hacker indicating whether the phone number is in its database or not (i.e., whether the owner of the phone number is a registered user of the application). For example, the hacker will receive messages such as “the phone number does not associate with any account,” or “SMS sent, please input the verification code.” Accordingly, by sending a large numbers of requests and analyzing the feedback messages, the hacker may illegally obtain the application's user fleet roster by user phone numbers. Sometimes when the number of two-step verification requests exceeds a threshold, a distributed denial of service (DDOS) malfunction is generated.

A protection mechanism can be used before a two-step verification to protect users from harassment, defeat hackers and avoid information leakage. However, if the verification mechanism to protect the login process is too complicated, even the legitimate users may not be able to pass the verification test and thus unable to login or further use the application. Therefore, design of the verification mechanism should balance the need to defeat a hacker AI engine, and the need to assure that legitimate users can pass the test and log into their accounts.

The disclosed system and method provide an improved login process protection by interactively training a mock hacker artificial intelligence (AI) engine and a challenge generation AI engine to compete with each other, thus providing login challenges with desired degree of difficulty and complexity.

### SUMMARY

Embodiments of the disclosure provide a method for protecting a login process to an application running on a device. The exemplary method includes interactively training a mock hacker artificial intelligence (AI) engine and a challenge generation AI engine to compete with each other. The challenge generation AI engine is configured to generate challenges that defeat hacking attacks by the mock hacker AI engine, and the mock hacker AI engine is configured to attack the challenges generated by the challenge generation AI engine. The exemplary method further includes generating a login challenge using the trained challenge generation AI engine. The exemplary method additionally includes providing the login challenge to a user attempting to access the application during the login process.

Embodiments of the disclosure also provide a system for protecting a login process. The exemplary system includes a storage device configured to store a verification challenge for protecting the login process. The exemplary system further includes a processor, configured to interactively train a mock hacker artificial intelligence (AI) engine and a challenge generation AI engine to compete with each other. The challenge generation AI engine is configured to generate challenges that defeat hacking attacks by the mock hacker AI engine, and the mock hacker AI engine is configured to attack the challenges generated by the challenge generation AI engine. The processor is also configured to generate a login challenge using the trained challenge generation AI engine, and provide the login challenge to a user attempting to access the application during the login process.

Embodiments of the disclosure also provide a method for protecting a login process to an application running on a device. The exemplary method includes generating a login challenge using a challenge generation AI engine interactively trained with a mock hacker artificial intelligence (AI) engine to compete with each other. The challenge generation AI engine is configured to generate challenges that defeat hacking attacks by the mock hacker AI engine, and the mock hacker AI engine is configured to attack the challenges generated by the challenge generator AI engine. The exemplary method further includes providing the login challenge to a user attempting to access the application during the login process. The exemplary method additionally includes allowing the user to proceed with the login process when the user solves the login challenge.

It is to be understood that both the foregoing general description and the following detailed description are exemplary and explanatory only and are not restrictive of the invention, as claimed.

### BRIEF DESCRIPTION OF THE DRAWINGS

FIGS. 1A and 1B illustrate schematic diagrams of exemplary verification images, according to embodiments of the disclosure.

FIG. 2 illustrates a block diagram of an exemplary system for protecting a login process, according to embodiments of the disclosure.

FIG. 3 is a flow chart of an exemplary method of interactively training a mock hacker artificial intelligence (AI) engine and a challenge generation AI engine to compete with each other, according to embodiments of the disclosure.

FIG. 4 is a flow chart of an exemplary method for training a challenge generation AI engine, according to embodiments of the disclosure.

FIG. 5 is a flow chart of an exemplary method for training a mock hacker AI engine, according to embodiments of the disclosure.

FIG. 6 is a flow chart of an exemplary method for generating a challenge to protect a user login process using a trained challenge generation AI engine, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide systems and methods for protecting a login process by requiring verification of a login using a challenge. Consistent with the present disclosure, a “login” process can be an account registration/sign up process where the user creates the account for the first time to access the application, or an account re-login process where the user uses his account credentials to access the application through an existing account. Descriptions of the disclosure apply to both the registration login process and the re-login process.

In some embodiments, a user can only proceed with a login process when the user solves the challenge correctly. When a user requests a login to access a computer or mobile application, either with a web-based application or a mobile application, the system determines a challenge to present to the user. A “challenge” can be implemented through different platforms. Exemplary platforms of challenges may include video recognition, word recognition, image verification, games, etc.

In some embodiments, the challenge may be designed to reflect attributes of each geographic market. Incorporating market-specific attributes into the challenges makes sure that the challenge is challenging enough to block a hacker or a hacker's automatic attacking artificial intelligence engine, while at the same time easy enough for the user to pass the challenge and continue the login process. In some embodiments, the attributes of the geographic market may include at least one of culture (e.g., pop culture), language (e.g., local dialect) and geographical information of the market. For example, the challenge can be an image of a local landmark for the user to recognize, a song in locally known pop music for the user to identify, a word or phrase that only local natives can understand, or other information familiar to local users.

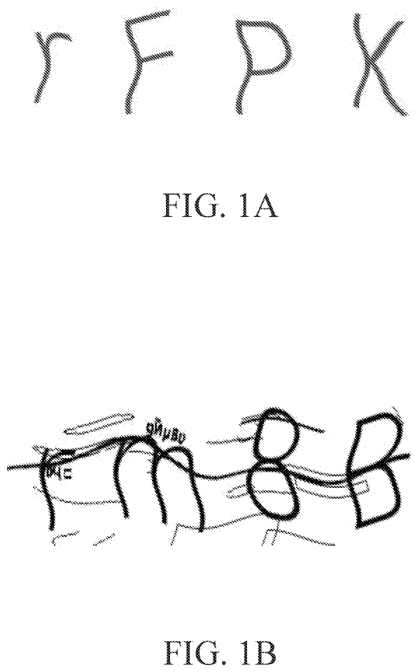

In some embodiments, the challenge can be a CAPTCHA test requiring the login requester to recognize a distorted character string (e.g., a sequence of letters, characters, numbers, or symbols collectively with or without a semantic meaning) displayed on a background with different degrees of noises. For example, FIGS. 1A and 1B illustrate schematic diagrams of exemplary CAPTCHA verification images, according to embodiments of the disclosure. The challenge can be designed by changing certain features of the challenge. For example, for a CAPTCHA test, features that can be tweaked include the content of the character string, the number of characters in the string, the font and font size, the distortion, and the level of background noise. By tweaking the features, the level of complexity of the challenge may be adjusted.

In some embodiments, one or more features of the challenge may reflect attributes of the specific target market. For example, character string displayed in a CAPTCHA test may include characters unique to a local language (e.g., a foreign language other than English or a local dialect different from a national language), thus hackers from a different geographic region or a different cultural background will have difficulty recognizing the characters, but local users will solve the challenge without problems. For example, both CAPTCHA strings shown in FIG. 1A and FIG. 1B include English letters or numbers that can be easily recognize by users in any English-speaking countries, thus suitable for targeting users in those countries.

The distortion and the background noises can be added to increase the level of complexity of the challenge. The more distorted and/or more background noises, the more difficult for a user to recognize the character string in the CAPTCHA test. For example, in FIG. 1A, the four English letters are slightly distorted with no background noise, while in FIG. 1B, the four English letters are more distorted with a certain degree of background noises. Therefore, the CAPTCHA test in FIG. 1B is more challenging to a user, as well as for a hacker AI engine.

In some embodiments, the disclosure provides systems and methods that generate localized challenges optimal for each specific market (e.g., ith market) and each specific platform (e.g., kth platform). The disclosed method trains two artificial intelligence (AI) engines, such as a challenge generation AI engine and a mock hacker AI engine, interactively to compete with each other. Consistent with the present disclosure, an AI engine may be an apparatus having AI computer programs thereon to perform artificial intelligence processing. For example, the challenge generation AI engine is configured to generate challenges that can defeat hacking attacks by the mock hacker AI engine, so that it can later generate challenges difficult enough to defeat real hack attacks in practice. The mock hacker AI engine, on other hand, is configured to attack the challenges generated by the challenge generation AI engine, to help the challenge AI engine improve its challenge generating capability. Sometimes manual validation process can also be included in the training process. The manual validation process is conducted by users who are familiar with the local culture and they can help determine the level of complication of the challenges generated by the challenge generation AI engine. When a mock hacker AI engine cannot defeat a challenge, the challenge can run through the manual validation process. If the manual validation process shows that the challenge will also defeat a local user, the challenge also fails the test and cannot be used. Only a challenge that can defeat the hacker attack while not defeating a local user is considered to pass the test. Challenges in practice are also used to train mock hacker AI engine.

In some embodiments, the system trains the pair of AI engines for each platform-market scenario, e.g., the (k, i) scenario for the kth platform and ith market. In some embodiments, one or more features of the challenge may be selected and designed based on geographical or cultural background associated with the target market. Some international hackers utilize a hacking mechanism that does not take into account the local culture and therefore can be defeated using challenges that require local knowledge, and at the same time these challenges will not defeat a real local user who triggers the login process.

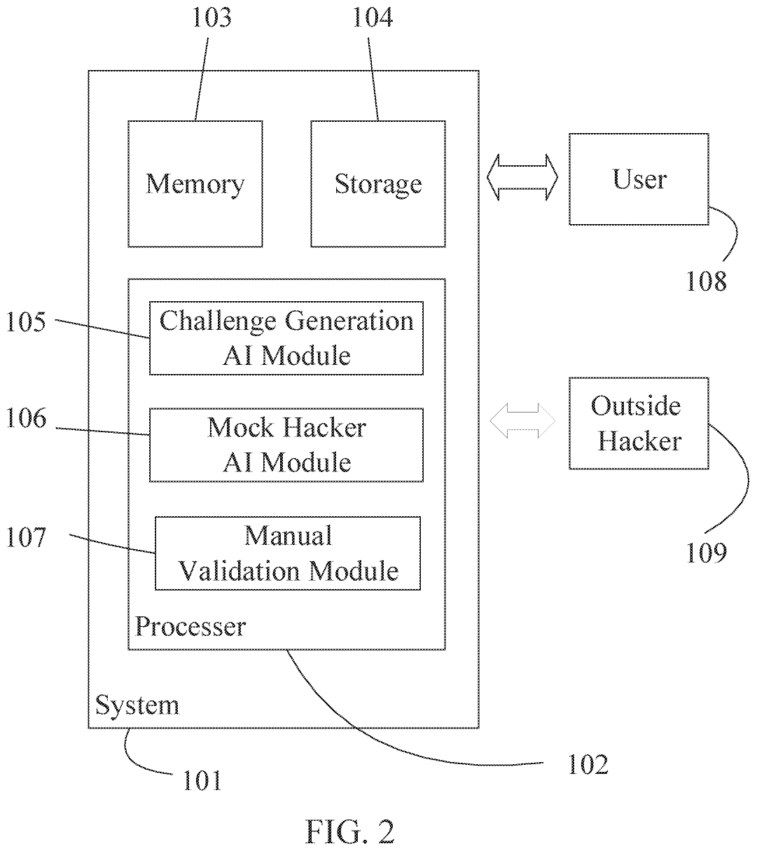

For example, FIG. 2 is a block diagram of an exemplary system 101 for protecting a login process, according to embodiments of the disclosure. In some embodiments, system 101 may be embodied on the device on which the application the user attempts to login is installed. In some other embodiments, system 101 may be external to the user device but connected with the user device through a network. For example, system 101 may be on an external server, or in the cloud.

In some embodiments, system 101 may include at least one processor, such as processor 102, at least one memory, such as memory 103 and at least one storage, such as storage 104. Processor 102 may include several modules, such as a challenge generation AI module 105, a mock hacker AI module 106 and a manual validation module 107. The system 101 may have interactions with a user 108 and a potential outside hacker 109. In some embodiments, system 101 may have different modules in a single device, such as an integrated circuit (IC) chip (e.g., implemented as an application-specific integrated circuit (ASIC) or a field-programmable gate array (FPGA)), or separate devices with dedicated functions. In some embodiments, one or more components of system 101 may be located in a cloud computing environment or may be alternatively in a single location (such as inside a mobile device) or distributed locations. Components of system 101 may be in an integrated device or distributed at different locations but communicate with each other through a network (not shown).

Processor 102 may include any appropriate type of general-purpose or special-purpose microprocessor, digital signal processor, or microcontroller. Processor 102 may be configured as a separate processor module dedicated to receiving login request from the user 108, and the outside hacker 109. Alternatively, processor 102 may be configured as a shared processor module for performing other functions unrelated to login request. Processor 102 may include one or more hardware units (e.g., portion(s) of an integrated circuit) designed for use with other components or to execute part of a program. The program may be stored on a computer-readable medium, and when executed by processor 102, it may perform one or more functions.

Memory 103 and storage 104 may include any appropriate type of mass storage provided to store any type of information that processor 102 may need to operate. Memory 103 and storage 104 may be a volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, and a static RAM. Memory 103 and/or storage 104 may be configured to store one or more computer programs that may be executed by processor 102 to perform functions disclosed herein. For example, memory 103 and/or storage 104 may be configured to store program(s) that may be executed by processor 102 to train the challenge generation AI engine and the mock hacker AI engine. Memory 103 and/or storage 104 may be further configured to store information and data used by processor 102.

Challenge generation AI module 105, mock hacker AI module 106 and manual validation module 107 (and any corresponding sub-modules or sub-units) can be hardware units (e.g., portions of an integrated circuit) of processor 102 designed for use with other components or software units implemented by processor 102 through executing at least part of a program. The program may be stored on a computer-readable medium, such as memory 103 or storage 104, and when executed by processor 102, it may perform one or more functions. Although FIG. 1 shows challenge generation AI module 105, mock hacker AI module 106 and manual validation module 107 all within one processor 102, it is contemplated that these modules may be distributed among different processors located closely or remotely with each other.

In some embodiments, challenge generation AI module 105 and mock hacker AI module 106 may be trained interactively to compete with each other. For example, challenge generation AI module 105 may be trained using sample challenges to optimize its ability to defeat those challenges. Mock hacker AI module 106 is then trained to optimize its ability to generate challenges that can defeat attempted attacks made by mock hacker AI module 106. Both challenge generation AI module 105 and mock hacker AI module 106 can be re-trained when their performances fall under expectation.

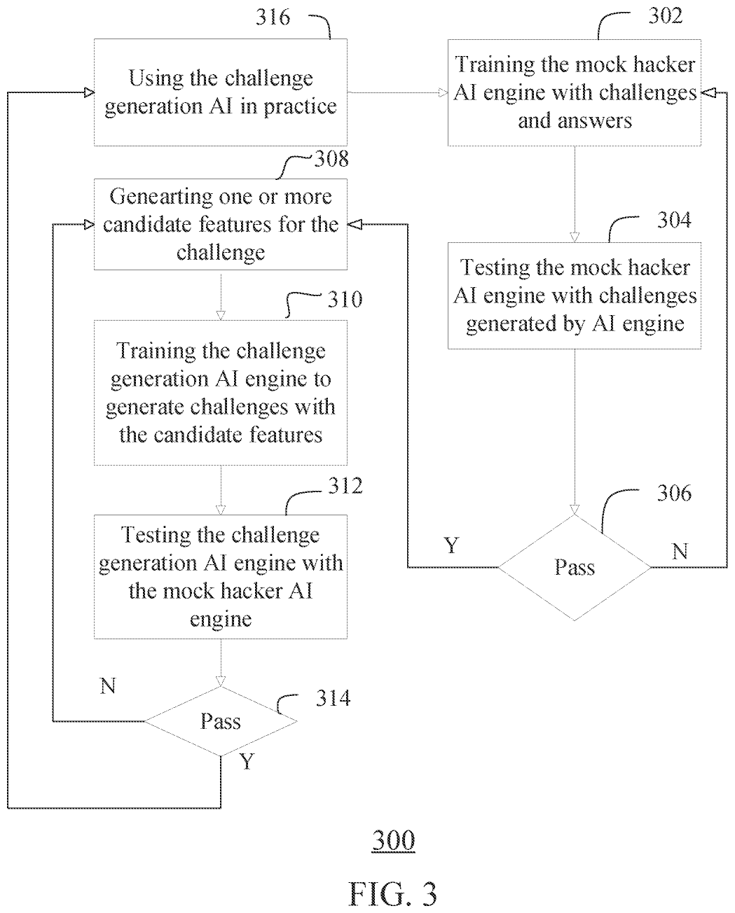

FIG. 3 illustrates a flow chart of an exemplary method 300 of interactively training a mock hacker artificial intelligence (AI) engine and a challenge generation AI engine to compete with each other, according to embodiments of the disclosure. Method 300 may be implemented by system 101 and may include steps 302-316 as described below. It is to be appreciated that some of the steps may be optional to perform the disclosure provided herein. Further, some of the steps may be performed simultaneously, or in a different order than shown in FIG. 3.

In step 302, the mock hacker AI module 106 trains the mock hacker AI engine with training samples including, e.g., pairs of randomly created challenges and their known answers. For example, the challenges may be generated by a random generator. Then the mock hacker AI engine is trained to mock a hacking actor to generate hacking attacks that can defeat these challenges.

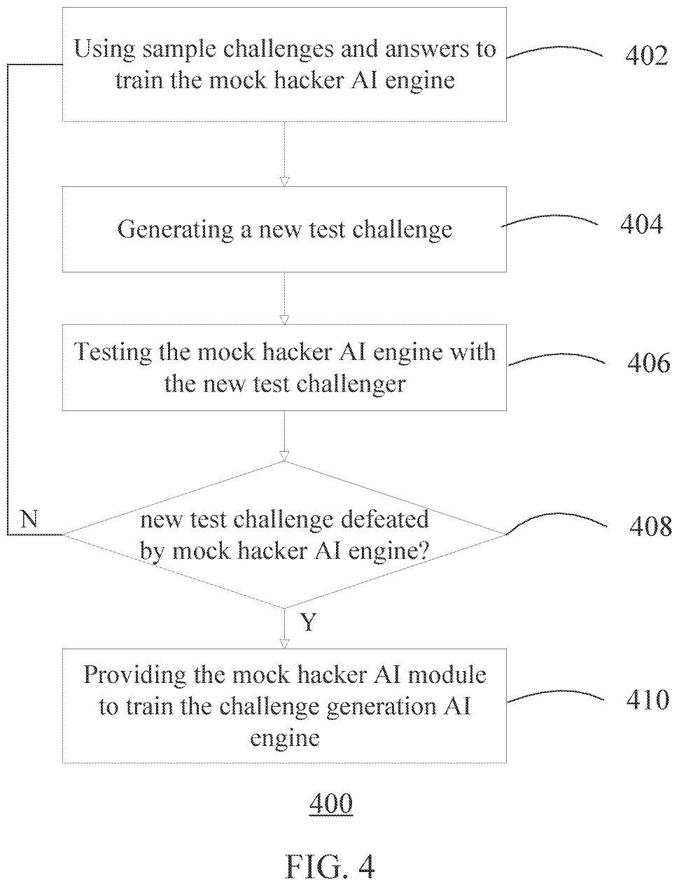

In step 304, the trained mock hacker AI engine is tested with a current challenge generation AI engine. For example, the challenge generation AI engine generates a set of new challenges and the mock hacker AI engine is tested by generating hacking attaches to the challenges. Training of the mock hacker AI engine will be described in more details in connection with FIG. 4.

In step 306, when challenges generated by the challenge generation AI engine are not defeated by mock hacker AI engine, the mock hacker AI engine passes the test (step 306: Y) and it will be temporarily stored as the current hacking actor for the scenario. When challenges generated by the challenge generation AI engine are defeated by the mock hacker AI engine (step 306: N), the mock hacker AI engine has to be retrained, e.g., by repeating steps 302-306.

In step 308, challenge generation AI module 105 is configured to generate one or more candidate features of a challenge designated to a geographic market. For example, if the platform of challenge (e.g., the kth platform) being trained is a CAPTCHA test that provides verification images as shown in FIGS. 1A and 1B, the candidate features can include one or more contents of the character string, the number of characters in the string, the distortion applied to the character string, and the level of background noise. In some embodiments, the features may be generated based on attributes of the target market (e.g., the ith market). For example, the characters in the string displayed in a CAPTCHA test may be from a local language (e.g., a foreign language other than English or a local dialect different from a national language), thus hackers from a different geographic region or a different cultural background will have difficulty recognizing the characters, but local users will solve the challenge without problems. As another example, the platform of the challenge may be to identify a song. In some embodiments, the song may be associated with the local pop culture so that local users are familiar with it, but international hackers may have no clue.

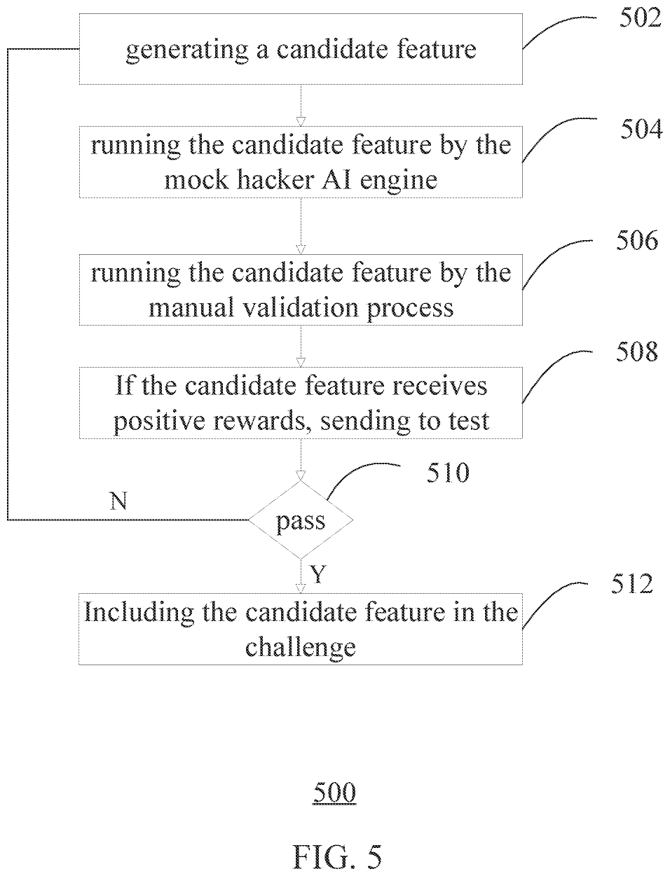

In step 310, challenge generation AI module 105 is configured to train a challenge generation AI engine by running challenges with the candidate features generated in step 308 through mock hacker AI module 106 and the manual validation module 107. A candidate feature generated by the challenge generation AI engine is included when the challenges generated by the challenge generation AI engine including the candidate feature defeats the mock hacker AI engine but does not defeat the manual validation. That means the feature is likely to defeat an outside hacker but will not defeat a real user when put in practice. The current mock hacker AI engine, trained through steps 302-306, may be used. When the mock hacker AI engine is applied to a challenge with the candidate feature, the mock hacker AI engine generates a first reward. The first reward is positive when the challenge defeats the hacking attacks by the mock hacker AI engine and negative when the candidate feature fails to defeat the hacking attacks by the mock hacker AI engine. When the candidate feature is tested by the manual validation module 107, the manual validation module 107 generates a second reward. The second reward is positive when the person successfully solves the challenge with the candidate feature in a manual validation test and negative when the person fails to solve the challenge. The candidate feature is included in the challenge when both the first reward and the second reward are positive. In some embodiments, only the features with a positive first reward will go to manual validation module 107 and receives a manual validation test, thus reduces the number of work that manual validation module needs to perform. In the example of a CAPTCHA test, the features, such degree of distortion and level of background noises applied to the character string may be trained in step 310. Training of the challenge generation AI engine will be described in more details in connection with FIG. 5.

In step 312, the challenge generation AI engine generates a number of test challenges with the feature determined in step 204, then the test challenges will be tested, e.g., by the current mock hacker AI engine (e.g., the one trained in step 304 and stored as the hacking actor), an offline OA mechanism of the system 201, real outside hackers, or real users.

In step 314, if the test challenges pass the test in step 312 (step 314: Y), the challenge generation AI engine that generates challenges with the candidate features will be provided for use in practice for the current scenario. Otherwise, if the test challenges do not pass the test (step 314: N), the challenge generation AI engine will be retained using steps 308-314 by generating different candidate features.

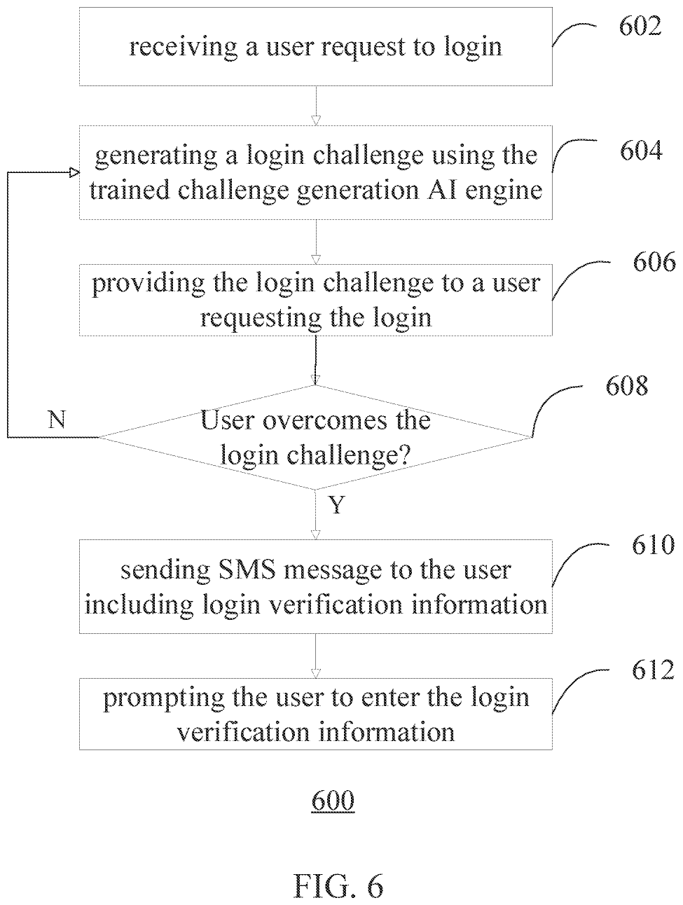

By training the mock hacker AI engine to compete with the current challenge generation AI engine in steps 302-306 and training the challenge generation AI engine to compete with the mock hacker AI engine in steps 308-314, the two AI engines are interactively trained for each scenario (e.g., the (k, i) scenario). In some embodiments, system 101 may train the AI engines for the multiple platforms for the ith market, and then combine the multiple platforms to randomly give challenges for the ith market. For example, in step 316, the challenge generation AI engine is used in practice to generate challenges for protecting the login process. An exemplary process of using the challenge generation AI engine will be described in connection with FIG. 6. In some embodiments, the challenges generated by challenge generation AI engine in practice may be further used to test the current mock hacker AI engine, and based on the result of the test, system 101 may decide whether mock hacker AI engine should be retrained through steps 302-306. In some embodiments, retaining may be warranted due to the threat landscape evolution or change of fraud trends. For example, a platform of pop-music related challenges may require a user to answer a multiple-choice question or fill in a blank to input the correct section of lyric from songs with some hints. However, the pop music rank of the week on December 12, 2020 may have changed drastically from the week of Nov. 7, 2020 on the billboard website.

If the mock hacker AI engine is retrained, the current mock hacker AI engine will be replaced with an updated mock hacker AI engine. System 101 may further determine whether the challenge generation AI engine should be retained, for example, by testing the challenge generation AI engine using the updated mock hacker AI engine using step 312. If it decides that challenge generation AI engine also needs to be retrained, it may perform steps 308-314 to retrain it. In some embodiments, system 101 may be designed to retain the AI engines periodically, at a predetermined frequency, e.g., every three days, every week, every month, etc.

FIG. 4 illustrates a flow chart of an exemplary method 400 for training a mock hacker AI engine, according to embodiments of the disclosure. Method 400 may be implemented by system 101, specifically mock hacker AI module 106 and may include steps 402-410 as described below. In some embodiments, method 400 may be performed to implement steps 302 and 304 in FIG. 3. It is to be appreciated that some of the steps may be optional to perform the disclosure provided herein. Further, some of the steps may be performed simultaneously, or in a different order than shown in FIG. 4.

In step 402, sample challenges and answers are used to train a mock hacker AI engine. In some embodiments, the sample challenges may be generated by a random generator, such as a challenge generation AI engine for a randomly selected platform. The mock hacker AI engine is trained to defeat the challenges generated by the challenge generation AI engine. For example, in some embodiments, the challenge generation AI engine generates sample challenges with four slightly distorted English letters with a certain degree of background noise, such as the one shown in FIG. 5B, as well as the corresponding answers to the challenges, such as a text answer of the four typed characters. The mock hacker AI engine is optimized during the training to successfully identify the characters in the challenges, thus defeating the challenges.

In step 404, the challenge generation AI engine generates an number of new test challenges to test the trained mock hacker AI engine. For example, in some embodiments, after the mock hacker AI engine is trained to identify challenges with four slightly distorted English letters with a certain degree of background noise in step 402, the challenge generation AI engine generates a number of new test challenges to test the mock hacker AI engine that whether the mock hacker AI engine can defeat new test challenges with the same feature or a modified feature.

In step 406, the mock hacker AI engine is tested by the new test challenges generated in step 404. The mock hacker AI engine may or may not be able to defeat the new test challenges.

In step 408, when the mock hacker AI engine fails to defeat the new test challenge (step 408: N), method 400 returns to step 402 to retain the mock hacker AI engine. When the new test challenge is defeated by the mock hacker AI engine (step 408: Y), in step 410, the mock hacker AI module 106 updates the mock hacker AI engine as the current version of the AI engine and the updated mock hacker AI engine will be used to interactively train the challenge generation AI engine in the process illustrated in FIG. 5.

FIG. 5 illustrates a flow chart of an exemplary method 500 for training a challenge generation AI engine, according to embodiments of the disclosure. Method 500 may be implemented by system 101, specifically challenge generation AI module 105, and may include steps 502-512 as described below. In some embodiments, method 500 may be performed to implement steps 308 and 310 in FIG. 3. It is to be appreciated that some of the steps may be optional to perform the disclosure provided herein. Further, some of the steps may be performed simultaneously, or in a different order than shown in FIG. 5.

In step 502, the challenge generation AI module 105 is configured to generate a candidate feature of a challenge for a specific market (e.g., the ith market). For example, for a CAPTCHA challenge, the candidate feature can be the language from which the characters are selected, the number of characters in the string, the degree of distortion, or the level of backgrounds.

In step 504, the candidate feature generated in step 302 is tested by the mock hacker AI engine. The mock hacker AI engine is trained to defeat challenges generated by the challenge generation AI engine with the candidate feature. The challenge generation AI engine generates multiple challenges with the candidate feature to be tested by the mock hacker AI engine. When the mock hacker AI engine tries to defeat a challenge with the candidate feature, it may or may not be able to defeat it.

Based on the outcome of the attack, the challenge generation AI engine will be rewarded with a negative or positive reward. In some embodiments, when the mock hacker AI engine fails to defeat challenges with the candidate feature, the mock hacker AI module 106 generates a positive first reward. For example, as illustrated in FIG. 1A and FIG. 1B, if the size of the small background letters becomes bigger (i.e., level of background noises higher), the hacking actor might fail the image verification test and the failed case will be positively rewarded. Otherwise, when the mock hacker AI engine defeats challenges with the candidate feature, a negative first reward is generated.

In step 506, the candidate feature generated in step 504 is tested by a manual validation process. The manual validation is conducted by a person who is associated with the target market (e.g., a local user, or a user familiar with the local language and culture). In some embodiments, step 506 is only performed when the candidate feature receives a positive first reward. Because the mock hacker AI engine can test a large number of challenges much faster than manual validation, by manually testing only the ones that have a positive first reward (i.e., survivor through the mock hacker AI engine), system 101 saves the time spent on manual validation process. In those embodiments, if the first reward is negative, method 500 skips steps 506-510 and directly return to step 502 to generate a new candidate feature. In some alternative embodiments, every candidate feature is tested by the manual validation process in step 506 regardless the first reward being positive or negative.

When the manual validation process succeeds to identify a challenge with the candidate feature, a positive second reward is generated. In some embodiments, the positive first reward may be increased to be the positive second reward. For example, the characters can be successfully identified by the manual validation process, such as the slightly distorted string as illustrated in FIG. 1A, and the candidate feature will receive a positive second reward.

Otherwise, when the manual validation process fails to identify a challenge with the candidate feature, the manual validation module 107 generates a negative second reward. In some embodiments, the positive first reward may be collapsed into the negative second reward.

For example, when too much distortion or background noise are added, e.g., as illustrated in FIG. 1B where the size and color of the background letters may be too close to the characters so that human cannot identify them during manual validation process, the candidate feature will receive a negative second reward.

In step 508, when the candidate feature receives both a positive first reward and a positive second reward, the candidate feature is sent for further test. For example, the degree of distortion as illustrated in FIG. 1A may be sent to test as a candidate feature if its first reward and second reward are both positive. As another example, the level of background noises as illustrated in FIG. 1B may not be sent to test as a candidate feature if it receives a positive first reward but a negative second reward.

In some embodiments, the first reward and the second reward can be designed to reflect a preference between protecting the login process from hacking activities and making sure the real users can proceed with the login process. In some embodiments, the rewards can be differently weighted. In some embodiments, when a large number of training data is available, a portion of the positive reward results can be sampled, and the human negative reward can be magnified accordingly to reflect the partial sampling.

In step 510, the challenge generation AI module 105 generates test challenges with the candidate feature. The test challenges can be tested by the current mock hacker AI engine, an offline OA mechanism of the system 101, real outside hackers or real users. When the result of the tests show that the candidate feature can defeat the hackers (mock or real) but can be solved by users, the candidate feature passes the test (step 510: Y). Accordingly, the candidate feature will be included in the challenge to be used in practice in step 512 and the challenge generation AI engine is updated with this candidate feature as well. When the result of the test show that the candidate feature fails the test (step 510: N), the process goes back to step 502 to generate another candidate feature and repeat steps 502-510.

FIG. 6 is a flow chart of an exemplary method 600 for generating a challenge to protect a user login process using a trained challenge generation AI engine, according to embodiments of the disclosure. In some embodiments, method 600 may be implemented by system 101 and may include steps 602-614 as described below. In some alternative embodiments, method 600 may be implemented by a system independent and separate from system 101. For example, method 600 may be performed by each user device that has the computer application to which the user attempts to access. Such user device may not train the challenge generation AI engine, but instead receive the interactively trained challenge generation AI engine from system 101. A user device may be a stationary device such as a desktop computer, a smart TV, etc., or a mobile device, such as a mobile phone, a wearable device, a tablet, a smart car, etc. It is to be appreciated that some of the steps may be optional to perform the disclosure provided herein. Further, some of the steps may be performed simultaneously, or in a different order than shown in FIG. 6.

In step 602, a user request to login to the application is received. For example, the user may click on a “sign in” or “login” button at the home page of the application to start the login process. In step 604, the trained challenge generation AI engine is used to generate a login challenge. The challenge generation AI engine may be trained interactively with a mock hacker AI engine, e.g., using method 300. The login challenge may include features that are tested and included during the training process. For example, a CAPTCHAR test with a character string distorted to a certain degree and/or added a certain level of background noises may be generated, such as the images shown in FIG. 1A or 1B. In another example, the login challenge may be a multiple-choice or blank-filling question asking the user to input the correct section of lyric from songs with or without some hints.

In step 606, the login challenge may be provided to the user requesting the login, e.g., on an interface of the user device. For example, a CAPTCHAR verification image as shown in FIG. 1A or 1B may be presented to the user, and an input box may be provided for the user to type in the characters they recognize from the verification image.

In step 608, a user response is received as an answer to the login challenge and if the answer is incorrect, it is determined that the user has failed the login challenge (step 608: N). In some embodiments, as shown in FIG. 6, method 600 may return to step 604 to generate a new login challenge to afford the user another chance. In some embodiments, a maximum number may be set for the login challenges, after which the user will be asked to try to login later. The login process is therefore protected from hackers who fail the login challenge for the determined number of times. Although not shown in FIG. 6, it is contemplated that method 600 may follow other protocols if the user fails the login challenge (step 608: N). For example, access restrictions (e.g., blocked from the application for an hour) or additional authentication requirements (e.g., have to call customer service to be manually verified) may apply.

If the answer provided by the user is correct, it is determined that the user has overcome the login challenge (step 608: Y). For example, if the user correctly types in rm8B in response to the CAPTCHA challenge shown in FIG. 1B, the user has overcome the challenge. The user will be permitted to proceed with in the login process. In some embodiments, an SMS message may to sent to the user in step 610 if she overcomes the login challenge. The SMS message may include login verification information, e.g., a verification code or a verification link. In step 612, the user is prompted to enter the login verification information provided by the SMS message. For example, the user is asked to enter the verification code in an input box on the login page, or to click on the verification link.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A method for protecting a login process to an application running on a device, comprising:
interactively training a mock hacker artificial intelligence (AI) engine and a challenge generation AI engine to compete with each other, wherein the challenge generation AI engine is configured to generate challenges that defeat hacking attacks by the mock hacker AI engine, and the mock hacker AI engine is configured to attack the challenges generated by the challenge generation AI engine;
generating a login challenge using the trained challenge generation AI engine; and
providing the login challenge to a user attempting to access the application during the login process.

2. The method of claim 1, wherein interactively training the mock hacker AI engine and the challenge generation AI engine to compete with each other further comprises:
determining one or more features of the challenges generated by challenge generation AI engine based on attributes of a predetermined market, wherein the challenges having the one or more features defeat the hacking attacks by the mock hacker AI engine and capable of being successfully solved in a manual validation test conducted by a person associated with the predetermined market.

3. The method of claim 2, wherein the attributes of the predetermined market include at least one of culture, language and geographical information of the predetermined market.

4. The method of claim 2, wherein determining one or more features of the challenges further comprises:
determining a first reward by applying the mock hacker AI engine to a challenge generated with a candidate feature;
when the first reward is positive, determining a second reward by performing the manual validation test on the challenge to obtain a second reward; and
including the candidate feature among the one or more features when the second reward is positive.

5. The method of claim 4, wherein the first reward is positive when the challenge generated with the candidate feature defeats the hacking attacks by the mock hacker AI engine and negative when the challenge fails to defeat the hacking attacks by the mock hacker AI engine.

6. The method of claim 4, wherein the second reward is positive when a person successfully solves the challenge generated with the candidate feature in a manual validation test and negative when the person fails to solve the challenge.

7. The method of claim 1, wherein interactively training the mock hacker engine and the challenge generation AI engine to compete with each other further comprises:
training the mock hacker AI engine using randomly created challenges;
testing the mock hacker AI engine using challenges generated by the challenge generation AI engine; and
retraining the mock hacker AI engine if the challenges defeat the hacking attacks by the mock hacker AI engine.

8. The method of claim 1, wherein interactively training the mock hacker engine and the challenge generation AI engine to compete with each other further comprises:
testing challenges generated by the challenge generation AI engine using the mock hacker AI engine; and
retraining the challenge generation AI engine if the challenges fail to defeat the hacking attacks by the mock hacker AI engine.

9. The method of claim 1, further comprises:
determining that the user solves the login challenge; and
allowing the user to proceed with the login process.

10. The method of claim 1, wherein allowing the user to proceed with the login process further comprises:
sending a short message services (SMS) message to the user comprising login verification information required to complete the login process; and
prompting the user to enter the login verification information.

11. A system for protecting a login process to an application, comprising:
a storage device configured to store a verification challenge for protecting the login process; and
a processor, configured to:
interactively train a mock hacker artificial intelligence (AI) engine and a challenge generation AI engine to compete with each other, wherein the challenge generation AI engine is configured to generate challenges that defeat hacking attacks by the mock hacker AI engine, and the mock hacker AI engine is configured to attack the challenges generated by the challenge generation AI engine;
generate a login challenge using the trained challenge generation AI engine; and
provide the login challenge to a user attempting to access the application during the login process.

12. The system of claim 11, wherein the processor is further configured to:
determine one or more features of the challenges generated by challenge generation AI engine based on attributes of a predetermined market, wherein the challenges having the one or more features defeat the hacking attacks by the mock hacker AI engine and capable of being successfully solved in a manual validation test conducted by a person associated with the predetermined market.

13. The system of claim 12, wherein the processor is further configured to:
determine a first reward by applying the mock hacker AI engine to a challenge generated with a candidate feature;
when the first reward is positive, determine a second reward by performing the manual validation test on the challenge to obtain a second reward; and
include the candidate feature among the one or more features when the second reward is positive.

14. The system of claim 13, wherein the first reward is positive when the challenge generated with the candidate feature defeats the hacking attacks by the mock hacker AI engine and negative when the challenge fails to defeat the hacking attacks by the mock hacker AI engine.

15. The system of claim 13, wherein the second reward is positive when a person successfully solves the challenge generated with the candidate feature in a manual validation test and negative when the person fails to solve the challenge.

16. The system of claim 11, wherein the processor is further configured to:
train the mock hacker AI engine using randomly created challenges;
test the mock hacker AI engine using challenges generated by the challenge generation AI engine; and
retrain the mock hacker AI engine if the challenges defeat the hacking attacks by the mock hacker AI engine.

17. The system of claim 11, wherein the processor is further configured to:
test challenges generated by the challenge generation AI engine using the mock hacker AI engine; and
retrain the challenge generation AI engine if the challenges fail to defeat the hacking attacks by the mock hacker AI engine.

18. The system of claim 11, wherein the processor is further configured to:
determine that the user solves the login challenge; and
allow the user to proceed with the login process.

19. A method for protecting a login process to an application running on a device, comprising:
generating a login challenge using a challenge generation AI engine interactively trained with a mock hacker artificial intelligence (AI) engine to compete with each other, wherein the challenge generation AI engine is configured to generate challenges that defeat hacking attacks by the mock hacker AI engine, and the mock hacker AI engine is configured to attack the challenges generated by the challenge generator AI engine;
providing the login challenge to a user attempting to access the application during the login process; and
allowing the user to proceed with the login process when the user solves the login challenge.

20. The method of claim 19, wherein allowing the user to proceed with the login process further comprises:
sending a short message services (SMS) message to the user comprising login verification information required to complete the login process; and
prompting the user to enter the login verification information.
